(19) United States
(12) Patent Application Publication
(10) Pub. No.: US 2009/0153348 A1
(43) Pub. Date: Jun. 18, 2009

(54) Method and apparatus for electronic-sign system

(76) Inventors: Li-Cheng Richard Zai, Los Gatos, CA (US); Xinyu Zang, Sunnyvale, CA (US); Sophia Fang-Jung Liu, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/008,528

(22) Filed: Jan. 11, 2008

Related U.S. Application Data
(60) Provisional application No. 61/007,466, filed on Dec. 13, 2007.

(51) Int. Cl. G09F 13/00; G08B 21/18

(52) U.S. Cl. 340/686.6; 340/815.53; 340/539.1; 340/5.1

(57) ABSTRACT

A method and apparatus that select presentation information for an electronic sign wirelessly placed within a proximity of one or more object items are described herein. The electronic sign displays the presentation information. An alert message is determined in response to a signal received from the electronic sign according to objects items in proximity locations of the electronic sign. The determined alert message is sent to the electronic sign to replace the displayed presentation information.

### CROSS-REFERENCE TO RELATED APPLICATIONS

This application is related to, and claims the benefits of, U.S. Provisional Patent Application No. 61/007,466, filed on Dec. 13, 2007 entitled “Methods and Apparatus for Electronic-Sign System”, Li-Cheng Richard Zai et al. which are hereby incorporated by reference herein in its entirety.

### FIELD OF INVENTION

The present invention relates generally to data processing systems. More particularly, this invention relates to electronic-sign systems.

### BACKGROUND

Electronic Sign (ESign) systems have been deployed in recent years. A typical electronic-sign system includes a plurality of electronic signs, multiple base stations, and a computer server. Electronic signs typically communicate with a computer server via a base station wirelessly. A computer server may include identification numbers of electronic signs and a database for product codes, descriptions of merchandise items, and commercial messages to be displayed by the electronic signs. A product code can be either a Universal Product Code (UPC) or an Electronic Product Code (EPC). An electronic sign is normally assigned to a group of merchandise items, so that it can display the commercial messages, such as the price or other promotion information, related to the specific items.

However, it can be difficult for this type of E-Sign systems to locate electronic signs in a large retail premise, such as a department store or a supermarket, where thousands of electronic signs can be deployed. This problem becomes more evident when an electronic sign uses an Electrophoretic Display (EPD) because the EPD display can still show commercial information without any power. In this case, it is difficult for store personnel to identify the specific electronic sign requiring services. Additionally, existing ESign systems do not usually support service calls by a customer or store personnel on the selling floor. As a result, customer questions or out-of-stock requests may not be answered in a timely manner. Furthermore, potential mismatches are not uncommon between a printed section and a programmable section of an electronic sign when the printed section is removed and inserted back without going through correct matching procedures.

Therefore, it is difficult to locate customers or electronic signs requesting services based on existing ESign systems.

### SUMMARY OF THE DESCRIPTION

An embodiment of the present invention includes a method and apparatus that select presentation information for an electronic sign wirelessly placed within a proximity of one or more object items. The electronic sign displays the presentation information. An alert message is determined in response to a signal received from the electronic sign according to objects items in proximity locations of the electronic sign. The determined alert message is sent to the electronic sign to replace the displayed presentation information.

In an alternative embodiment, an electronic sign displays presentation information at a display in response to wirelessly receiving an identifier which represents or matches a machine readable code (e.g. bar code) printed on a surface of an object at a location within a proximity of the electronic sign. The presentation information is associated with the identifier at a remote server. An absence of the object from the location is detected while the presentation information is being displayed. Subsequently, a notification signal is wirelessly sent to the remote server. Accordingly, alerts are activated based on alert messages from the remote server receiving the notification signal.

In another alternative embodiment, one or more electronic signs are communicatively (e.g. wirelessly) coupled to a server to display presentation information. An electronic sign wirelessly receives an identifier which may identify or match a machine readable code printed on a surface of an object at a location within a proximity of the electronic sign. The presentation formation is associated with the identifier at the server (e.g. stored in a database of the server). An absence of the object from the location is detected while the presentation information is being displayed. Accordingly, the electronic sign sends a notification signal to the server. A response signal is received from the server to activate alerts based on the notification signal.

Other features of the present invention will be apparent from the accompanying drawings and from the detailed description that follows.

### DESCRIPTION OF THE DRAWINGS

The present invention is illustrated by way of example and not limitation in the figures of the accompanying drawings, in which like references indicate similar elements and in which:

FIG. 1 is a network diagram illustrating one embodiment of an electronic-sign (ESign) system;

FIG. 2 illustrates an embodiment of electronic signs located in coverage areas associated with multiple electronic-sign base stations;

FIG. 3 is a block diagram illustrating one embodiment of a system for an electronic sign in an ESign system;

FIGS. 4A, 4B, and 4C illustrate examples of electronic signs displaying messages based on printed sections according to one embodiment of the present invention;

FIG. 5 is a block diagram illustrating one embodiment of a system for an ESign server that manages electronic signs;

FIG. 6 is a flow diagram illustrating one embodiment of a process to transmit an alert message according to a signal wirelessly received from an electronic sign;

FIG. 7 is a flow diagram illustrating one embodiment of a process to send a wireless notification to activate an alert via an electronic sign;

FIG. 8 is a sequence diagram illustrating one embodiment of locating customers and electronic signs based on alert indicators in an ESign system;

FIG. 9 illustrates an exemplary embodiment of a station alert device;

FIG. 10 illustrates an exemplary data processing system which may be used in an embodiment of a station alert device of the present invention;

FIG. 11 illustrates one example of a typical computer system which may be used in an ESign server in conjunction with the embodiments described herein.

### DETAILED DESCRIPTION

A method and an apparatus for electronic sign systems are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, electronic signs and base stations are associated with one or more input/output (IO) devices such as, for example, inputs, alerting indicators and/or sensors to assist locating where services are requested, such as a customer request or updating an electronic sign. Sensors integrated with electronic signs may detect mismatches between a location specific object, such as printed sections located together with electronic signs, and displayed messages. Alert messages are received to prevent displaying mismatched promotional messages.

According to one embodiment, an electronic-sign system includes at least one computer server and one or more station alert devices, such as base stations or access points, and electronic signs. Location associations among electronic signs, base alert devices and display messages may be stored in the computer server. Notification signals from electronic signs may be triggered according to sensors or associated IO devices with electronic signs or base stations. A computer server determines alert messages based on received notification signals to activate alert devices or change display messages for electronic signs and/or station alert devices.

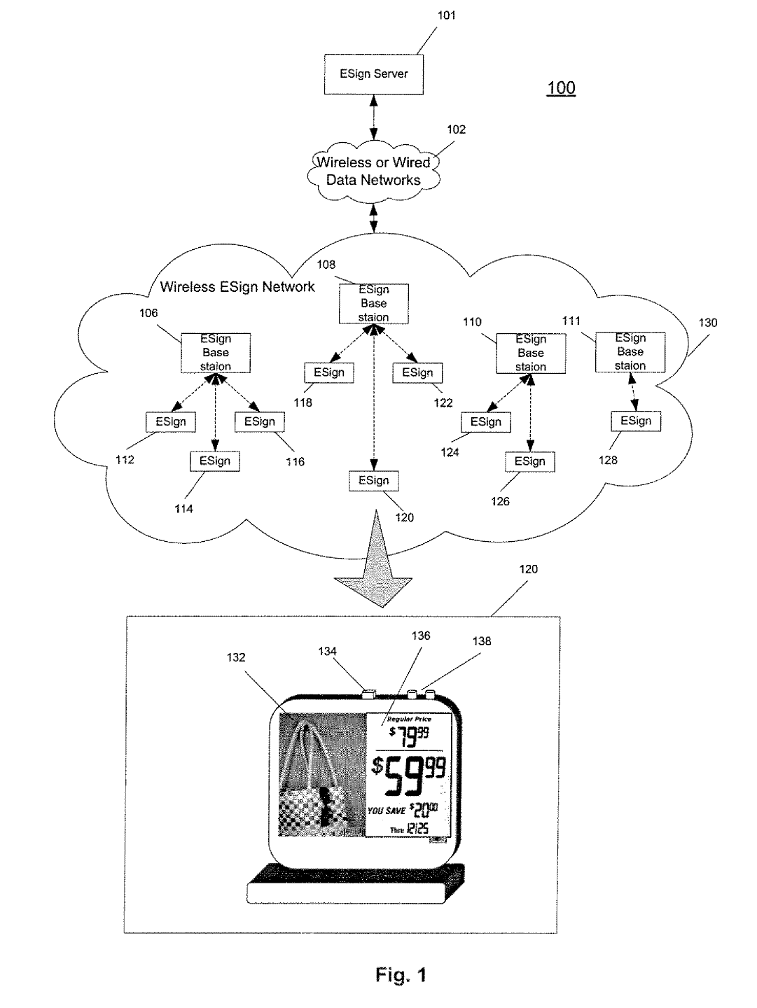

FIG. 1 is a network diagram illustrating one embodiment of an electronic-sign (ESign) system. In one embodiment, ESign system 100 may include multiple electronic signs, for example, ESign 112 to ESign 128. An electronic sign may include a movable information display coupled with a wireless device, e.g. ZigBee radio. One or more electronic signs, such as ESign 112 to ESign 128, may be associated with a base station or repeater, such as ESign base station 106, over a wireless ESign network, such as ESign network 130. An electronic sign may include a wireless transceiver that is capable of wirelessly communicating with another wireless endpoint such as a base station (e.g., an access point) or server. For example, an electronic sign may be an RF (Radio Frequency) or an IR (Infrared) compatible device. An electronic sign, such as ESign 112, may perform wireless network transactions with its associated base station, such as ESign base station 106. A base station may be placed at a relatively fixed location to serve as a hub and/or a gateway between a data network, e.g. data network 102, and electronic signs ESign 112 to ESign 128. In one embodiment, a base station, such as ESign base station 106, may receive and monitor wireless data packets from a wireless device not currently associated, such as ESign 128 associated with ESign base station 110 but not with ESign base station 106. More than one base stations may be placed at multiple locations to provide coverage over an area, such as a store space.

An electronic sign, such as ESign 112, of ESign network 130 may be coupled with a store ESign server 101 over a data network 102 via a base station, such as ESign base station 106. Data network 102 may be a wireless or wired network. Data network 102 may further include multiple networks or sub-networks. ESign server 101 may be located locally or remotely with respect to electronic signs ESign 112 to ESign 128 of ESign network 130. A store ESign server 101 may receive, periodically or on demand, physical measurements of wireless signals for a wireless device, such as the received signal strength (RSS) of an electronic sign 112. In one embodiment, an ESign store server, such as server 101, may provide location tracking capability for ESign 112 based on its association with base station 106. Decisions may be made at an ESign store server to manage electronic messages to be displayed by an electronic sign. In one embodiment, ESign 120 may include input devices 138, such as push buttons or touch sensors, alert indicators 134, such as light-emitting devices (LED) or an audio device, a printed section 132, and a programmable section 136. An ESign server, such as ESign server 101, may control an ESign device, such as ESign 120, to determine what commercial messages to display and/or what alert indicators to activate. In another embodiment, an ESign servr may remotely control alert devices located throughout an area where ESign devices are positioned.

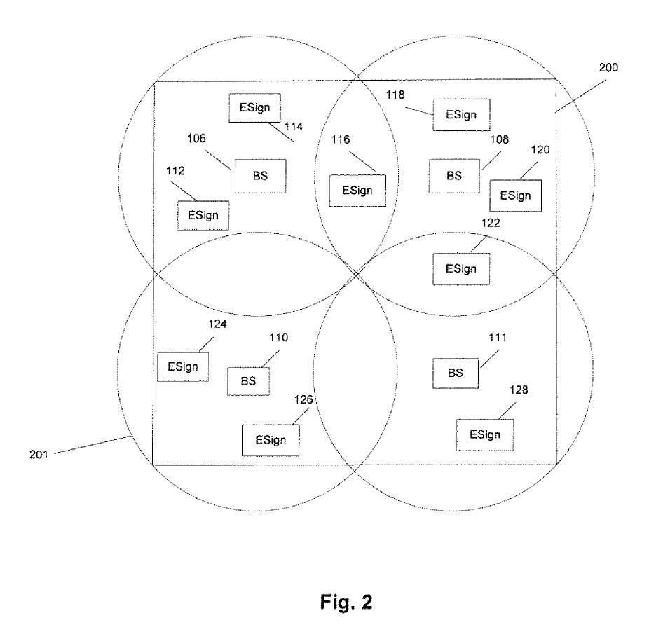

FIG. 2 illustrates an embodiment of electronic signs located in coverage areas associated with multiple electronic-sign base stations. Base stations 106, 108, 110 and 111 may be geographically placed at multiple points of area 200. Base stations 106, 108, 110, and 111 may be placed according to a location map stored at ESign server 101. The radius of the coverage area associated with a base station, such as area 201 of base station 110, is typically between 10 to 30 meters; however, smaller or larger radius may be implemented dependent upon a specific configuration of a floor plan. Certain ESign devices, such as ESign 112, 114, 118, 120, 124, 126, or 128, may be covered by and associated with a single base station. When an ESign device, such as ESign 116 or ESign 122 is covered by more than one base station, it may be assigned to a selected base station with or without human intervention. In one embodiment, an ESign may be automatically associated with a base station with the strongest RSS (Received Signal Strength) indicator among those overlapping base stations. In another embodiment, an ESign server may prompt a store staff to choose a base station from a list describing overlapping base stations for an ESign device. An ESign server, such as ESign server 101, may keep track of the location of an ESign based on the location of its associated base station.

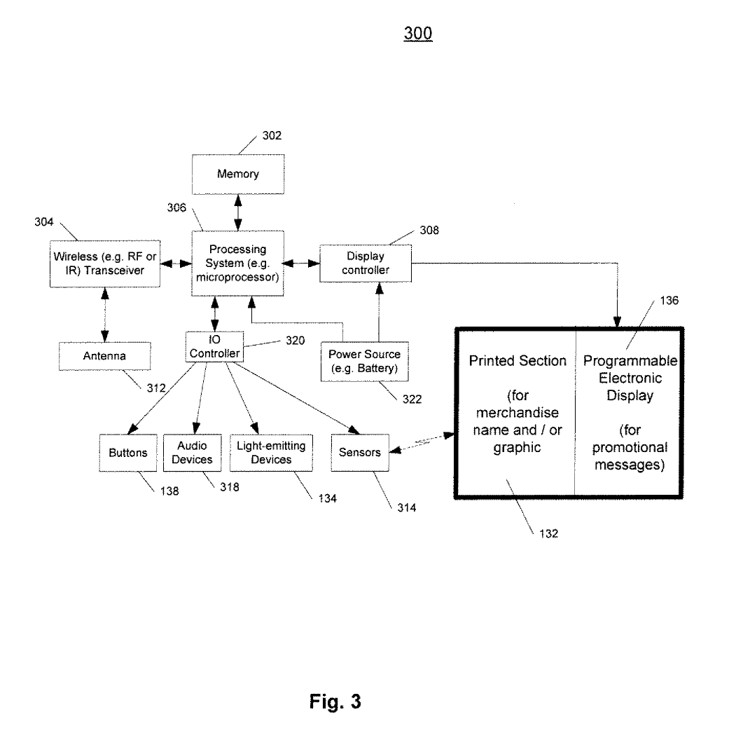

FIG. 3 is a block diagram illustrating one embodiment of a system for an electronic sign in an ESign system. In one embodiment, system 300 may include a processing system 306 which may be one or more microprocessors, such as a system on a chip integrated circuit. System 300 may include a memory 302 for storing data and programs executable by a processing system 306. A display 136, such as a LCD or an EPD, may be coupled to a processing system 306 via a display controller 308. An IO controller 320 may be coupled with multiple IO devices, such as buttons 138, audio devices 318, light-emitting devices 134, and sensors 314. In one embodiment, service requests may be generated from an ESign when a coupled IO device, such as button 138, is activated by a customer or store staff. In another embodiment, an audio device 318 and/or a light-emitting device 134 may generate guiding signals according to an ESign server to facilitate locating a customer or an ESign device requesting services.

According to one embodiment, an ESign device, such as ESign 120, may include two-sided displays. Each side of a two-sided display may be associated with printed sections, such as printed section 132, programmable sections, such as programmable section 136, and sensors, such as sensor 314. Sensor 314 may monitor the presence of printed sections to send a signal to processing system 306 via IO controller 320 according to whether the printed sections are present or not. In one embodiment, a sensor may be a mechanical micro switch or an optical detector. If sensor 314 sends a signal indicating the absence of a printed section, processing system 306 may control programmable section 136 to display a default messages stored locally or received remotely from ESign server 101. A default message may be, for example, a blank screen or a message without any promotional or pricing information.

In one embodiment, system 300 may include one or more wireless transceivers, such as transceiver 304, to communicate with another data processing system. A wireless transceiver may be an RF transceiver for a ZigBee network. An antenna system, such as antenna 312, may be coupled with wireless transceiver 304. Optionally, system 300 may include a power source 322, such as a built-in battery or a replaceable or rechargeable battery. In one embodiment, power source 322 may be based on solar energy source or driven by an external energy source. It will be appreciated that additional components, not shown, may also be part of the system 300 in certain embodiments, and in certain embodiments fewer components than shown in FIG. 3 may also be used in a data processing system. For example, the system 300 may only have the programmable section 136, such as LCD or EPD, without printed section 132 and sensor 314.

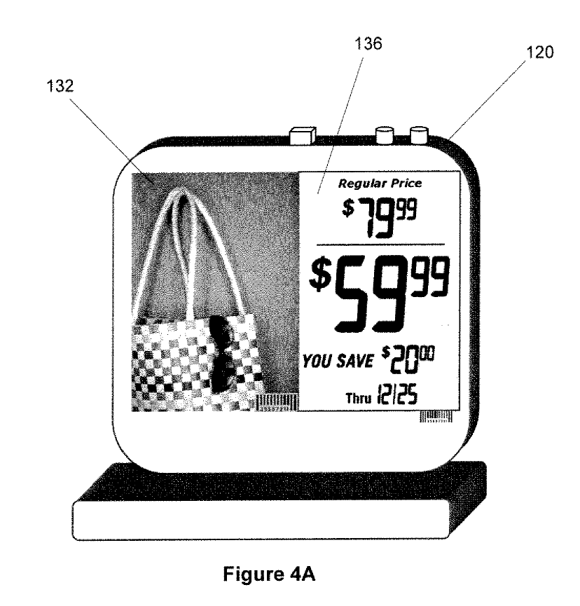

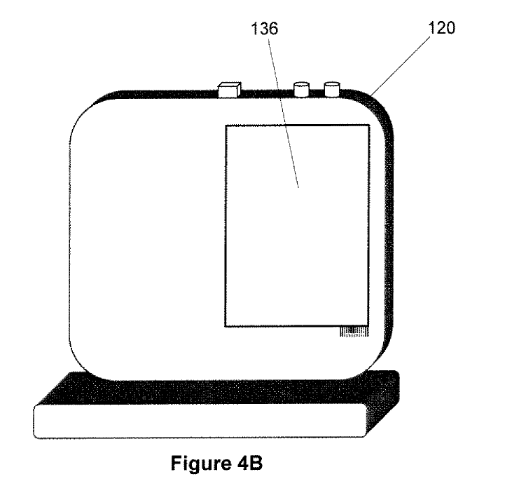

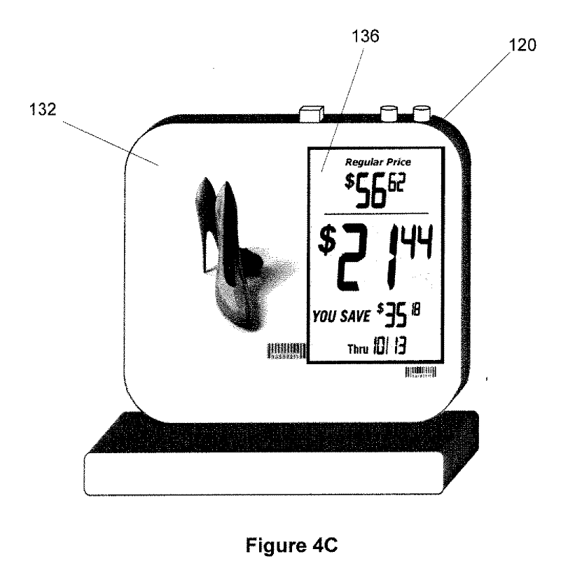

FIGS. 4A, 4B and 4C illustrate examples of electronic signs displaying messages based on printed sections according to one embodiment of the present invention. In one embodiment, changes in a printed section may cause updates in messages displayed in an associated ESign. Referring to FIG. 4A, ESign 120 may display commercial messages, such as sales information, subsequent to inserting printed section 132 according to a matching procedure, such as described in a co-pending U.S. patent application Ser. No. 11/823,064 filed on Jun. 25, 2007, entitled “Location Based Electronic Sign System” (hereinafter “064 application”), having common inventorship as well as assignee with the present application, which is hereby incorporated herein by reference. The matching procedure ensures that ESign messages are displayed correctly according to changes in printed section 132, such as a printed section replacement. To prevent an ESign from displaying incorrect or outdated messages inconsistent with a printed section, in one embodiment, an ESign may monitor changes in associated printed sections to enforce the matching procedure.

Turning to FIG. 4B, ESign 120 may display a default message subsequent to detecting an absence of a printed section, such as according to sensor 314 of FIG. 3 detecting the removal of printed section 132. A default messages may be a blank screen without any promotional information. In one embodiment, changes in displayed messages may be controlled according to a programmable section, such as section 136 of FIG. 3, coupled with a processing system, such as system 306 of FIG. 3. In FIG. 4C, ESign 120 may display updated commercial messages associated with a newly inserted printed section, such as printed section 132 showing a new product. In one embodiment, if a matching procedure fails to perform or fails to successfully complete for inserting a new printed section, an ESign may keep a default message displayed to prevent displaying inconsistent messages between associated printed sections and programmable displays. A default message may alert an operator to complete a matching procedure when a printed section is updated for an ESign device.

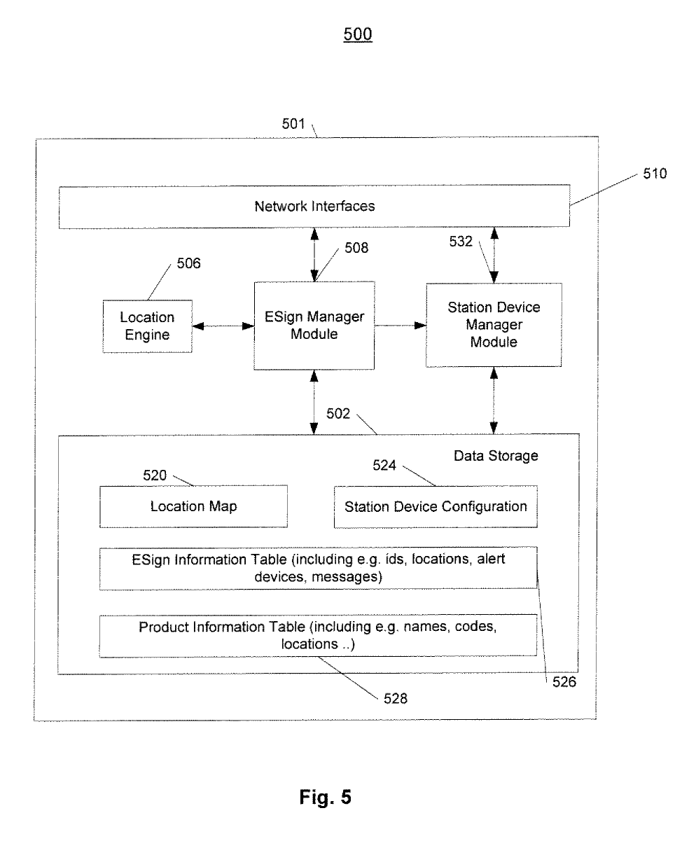

FIG. 5 is a block diagram illustrating one embodiment of a system for an ESign server that manages electronic signs. In one embodiment, ESign server 101 of FIG. 1 may be based on system 500. Network interface 510 of system 500 may provide interfaces for both wired, such as Ethernet, or wireless, such as RF or IR networks. In one embodiment, ESign manger module 508 may receive via network interface 510 a signal indicating a change of a printed section from an ESign, such as Printed section 132 in ESign 120 of FIG. 1. In one embodiment, a signal received from an ESign may include an identifier associate with the originating ESign. ESign manager module 508 may identify an ESign from ESign information table 526 according to the identifier in a received signal. In another embodiment, Location engine 506 may derive a location of an originating ESign from the signal received according to Location map 520. ESign manager module 508 may retrieve an entry associated with an ESign from ESign information table 526 based on the determined location. System 500 may match a display message retrieved from ESign information table 526 with a printed section of an ESign.

In one embodiment, ESign manager module 508 may determine a default message for a signal received from an ESign indicating an absence of an associated printed section. A default message may be a blank message such as shown in display 136 of ESign 120 of FIG. 4B. In some embodiments, a default message may be associated with products located in a proximity of an ESign according to Product information table 528 based on a location of the ESign. For example, a default message may include a category of products associated with an ESign without detailed sale information. In one embodiment, ESign manager module 508 may generate a response message including alert commands to activate an alert device associated with an ESign according to ESign information table 526. An alert command may include an alert pattern, such as, for example, frequency of flashing for a light emitting device or a sound pattern for an audio alert device. In one embodiment, ESign manager module 508 may notify a station device to activate an alert via a station device manager module 532. Station devices may be positioned in coverage areas associated with ESgins, such as ESign base station 106 or other dedicated alert devices. In one embodiment, ESign manager module 508 may forward a location to Station device manager module 532 to determine one or more station devices associated with the location based on Station device configuration 524. In one embodiment, Station device configuration 524 may include associations with ESign devices as stored in ESign information table 526. Station device manager module 532 may send an activation command including an alert pattern according Station device configuration 524 and a location received from ESign manager module 508. System 500 may forward an activation command to a station device via network interface 510 over wired or wireless networks.

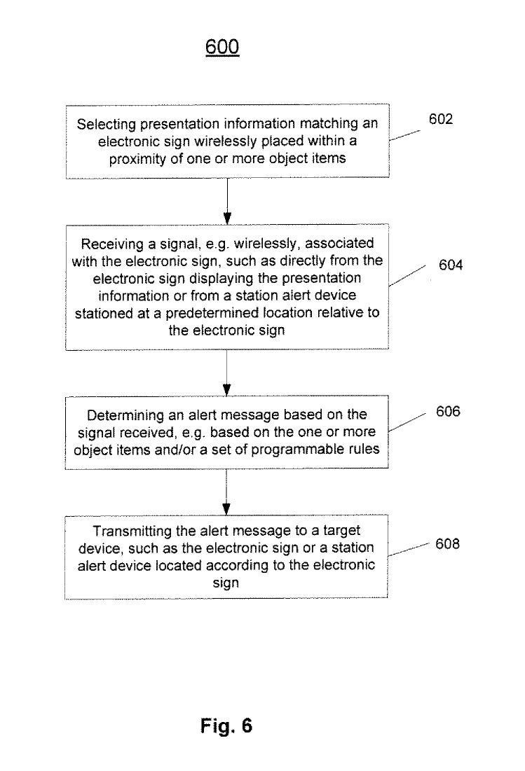

FIG. 6 is a flow diagram illustrating one embodiment of a process to transmit an alert message according to a signal wirelessly received from an electronic sign. Exemplary process 600 may be performed by a processing logic that may include hardware (circuitry, dedicated logic, etc.), software (such as is run on a dedicated machine), or a combination of both. For example, process 600 may be performed by some components of system 500 of FIG. 5. At block 602, the processing logic of process 600 may select presentation information matching an electronic sign, such as ESign 120 in FIG. 4A. Presentation information may be selected according to object items placed in a proximity of an ESign, such as based on ESign information table 526 and product information table 528 of FIG. 5. In one embodiment, presentation information may be selected to match an ESign device according to a printed section of the ESign device, such as printed section 132 of ESign 120 of FIG. 4A. The processing logic of process 600 may perform selecting operations for presentation information associated with an ESign device based on a matching process as described in the co-pending 064 application. The selected presentation information may be forwarded to an ESign device wirelessly via a base station, such as Base station 106 of FIG. 1.

In one embodiment, at block 604, the processing logic of process 600 may receive a signal from a device, such as an ESign displaying the transmitted presentation information or a station alert device stationed at a predetermined location associated with one or more ESign devices. A signal including an identifier identifying an originating ESign may be received wirelessly via a base station, such as Base station 106 of FIG. 1. Additionally, the signal may indicate a printed section of an ESign, such as printed section 132 of ESign 120 in FIG. 4A, is detected missing. The received signal may indicate a service request issued through an ESign. The processing logic of process 600 may update a status stored for an ESign device corresponding to a received signal, such as in ESign information table 526 of FIG. 5.

In one embodiment, a received signal may originate from a station alert device, such as ESign base station 106 of FIG. 1, or a generic alert device including audio or visual alert capabilities. The processing logic of process 600 may receive a signal when a service is requested by a staff member or a customer. A station alert device may be stationed at a predetermined location. In one embodiment, a station alert device may include one UP button and one DOWN button or alternatively, one or more touch sensors. Location information associated with a station alert device may be programmed via UP and DOWN buttons. Additionally, a station alert device may include a location indicator which displays location information to assist verification that a station alert device is installed at a correct location. A signal originated from a station alert device may include a station ID and location information associated with the station alert device.

At block 606, the processing logic of process 600 may determine an alert message according to a signal received. In one embodiment, the processing logic of process 600 may identify an ESign according to an identifier extracted from a received signal to determine an alert message, such as based on ESign information table 526 of FIG. 5. The processing logic of process 600 may extract a station ID and a location from a received signal to compare the extracted location with a configured location according to the station ID, such as based on Alert device configuration 524 of FIG. 5. When a discrepancy is detected between a received location and a configured location, an alert message may be generated.

In one embodiment, an alert message may include a default display message, such as a blank message, if a received signal indicates a missing printed section in an ESign device. The processing logic of process 600 may determine an alert message including a repetitive light flash pattern for a light emitting alert device when a received signal indicates a service request. An alert message may include an alert command to activate an alert device, such as a light emitting device or an audio device. An alert device may be associated with an ESgin, a base station, or a stand alone alert device configured through an ESign server, such as ESign server 501 of FIG. 5. In one embodiment, an alert message may include an alert pattern to allow a single alert device to emit multiple alert messages. An alert message may include default product information related to object items located in a proximity area around an identified ESign device. In one embodiment, the processing logic of process may determine an alert message based on a set of programmable rules, such as stored in Alert device configuration 524 or ESign information table 526 of FIG. 5. At block 608, the processing logic of process 600 may transmit the determined alert message to a target alert devices. An alert message may be transmitted wirelessly directly or indirectly via intermediate devices, such as base stations. In response to a received signal, more than one alert devices may be selected as target alert devices. For example, the processing logic of process 600 may send a command to active an alert device coupled with a base station in addition to transmitting a default display message to an ESign device associated with the base station. Selecting target alert devices may be based on locations determined from a received signal according to pre stored configurations, such as in Data storage 502 of FIG. 5.

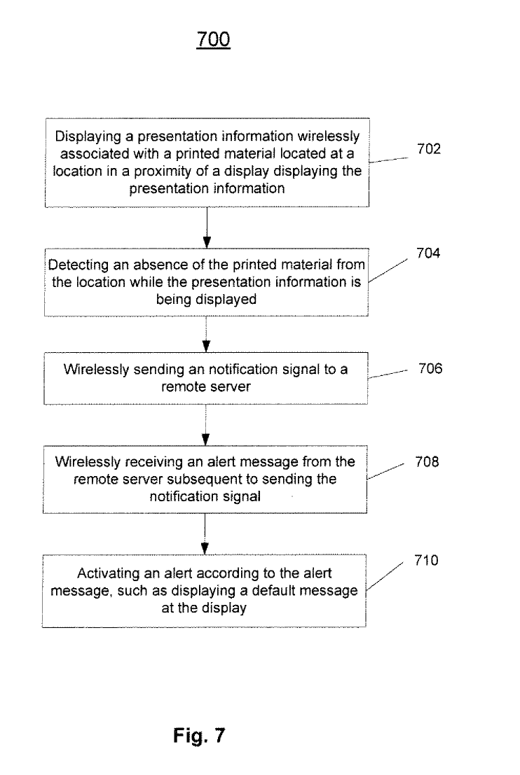

FIG. 7 is a flow diagram illustrating one embodiment of a process to send a wireless notification to activate an alert via an electronic sign. Exemplary process 700 may be performed by a processing logic that may include hardware (circuitry, dedicated logic, etc.), software (such as is run on a dedicated machine), or a combination of both. For example, process 700 may be performed by some components of system 400 of FIG. 4. At block 702, the processing logic of process 700 may display presentation information, such as promotional messages 136 of FIG. 1, wirelessly received from a remote server, such as ESign server 101 of FIG. 1, to match a locally associated printed section, such as Printed section 132 of FIG. 1. In one embodiment, a display message may match a printed section according to a matching process as described in the co-pending 064 application. Subsequently at block 704, in one embodiment, the processing logic of process 700 may detect an absence of a printed material in a printed section matching a display message. An absence of a printed material may be detected by a sensor such as sensor 314 of FIG. 3. Removal of a printed section, such as printed section 132 of FIG. 3, may cause a sensor to detect an absence of a printed section. In one embodiment, a sensor may monitor a presence of a printed section located at a predetermined location repetitively based on a predetermined frequency. An absence of a printed section may be determined if a presence of the printed section is not detected for a period of time longer than a predetermined period.

At block 706, the processing logic of process 700 may wirelessly send a notification message to a remote server, such as ESign server 101 of FIG. 1, to indicate detected absence of a printed section matching a display message. A notification message may include identifiers such as an ESign ID, a display ID, and a sensor ID. A display ID and a sensor ID may be used to identify a specific display section of an ESign associated with multiple printed sections, such as a double-sided ESign including more than one display sides. Each display side may be associated with a programmable section ID and a sensor ID.

In one embodiment, a notification message may be generated according to an activation of an IO device, such as pushing Button 138 of FIG. 3. A notification message may indicate a service request when generated via an IO device. Subsequently at block 708, the processing logic of process 700 may wirelessly receive an alert message from a remote server, such as ESign server 101 of FIG. 1. An alert message may be determined based on identifiers included in a notification message sent at block 706. At block 708, the processing logic of process 700 may activate an alert according to an alert message received. In one embodiment, the processing logic of process 700 may extract a default display message from a received alert message to display at a programmable section of an ESign, such as section 136 of FIG. 3. A message currently being displayed may be replaced or modified by the extracted default display message. The processing logic of process 700 may active coupled alert devices, such as audio devices 318 or light emitting devices 134 of FIG. 3, according to an alert pattern included in a received alert message.

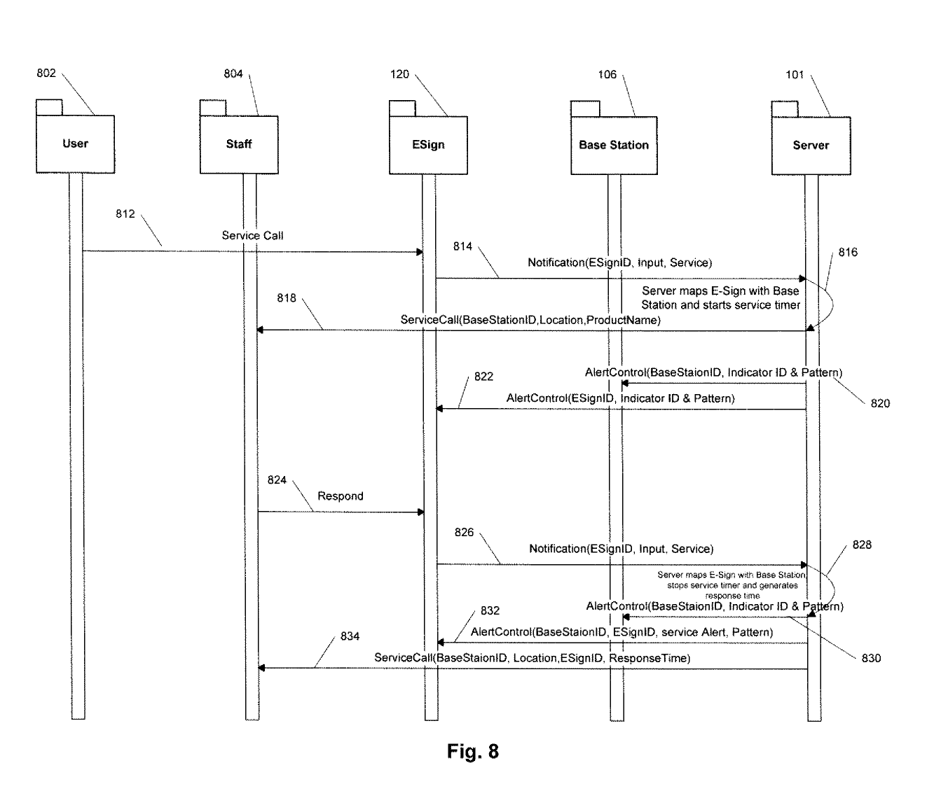

FIG. 8 is a sequence diagram illustrating one embodiment of locating customers and electronic signs based on alert indicators in an ESign system. A user 802 presses buttons of ESign 120 to initiate a service call at sequence 812. In accordance, ESign 120 may send a notification packet, including an ESign ID, input data, and a service request, to ESign server 101. In one embodiment, input data may include information indicating a particular button being pressed or the time and sequence of one or multiple buttons being pressed. In another embodiment, a service request may be associated with displayed messages and button inputs. For example, if ESign 120 shows sales information when a button is pressed, a service request from ESign 120 may be a customer call. On the other hand, if ESign 120 shows product name when a button is pressed, a service request from ESign 120 may indicate an out of stock service is required.

At sequence 816, ESign server 101 may look up a base station ID, location information, and/or product information based on an ESign ID received to determine an alert message, such as according to Station device configuration 524, ESign information table 526 and Product information table of FIG. 5. ESign server 101 may also start a service timer subsequent to receiving a notification packet. At sequence 818, ESign server 101 may send an alert message including a base station ID, location information, and product names to a target alert device, such as an alert device including a large electronic display, to be notified by a staff personnel 804. In one embodiment, ESign server 101 may send an alert message to a wireless pager to be received by a staff personnel 804.

At sequence 820, Server 101 may send an alert message, AlertControl packet, including a base station ID, an indicator ID and a display pattern, to Base station 106. In one embodiment, base station 106 may blink a particular LED device with a specific on and off pattern according to a display pattern received. At sequence 822, Server 101 may send another alert message including an ESign ID, and an indicator ID and a display pattern to ESign 120. In one embodiment, ESign 120 may blink a particular LED device with a specific on and off pattern according to a display pattern received. Note that ESign server 101 may send product promotion information to Base station 106 and ESign 120 for product promotion via associated indicators independent of a notification packet.

At sequence 824, ESign 120 may send another notification packet indicating completion of a service to ESign server 101 when a staff responds to the service call and presses buttons associated with ESign 120. In response, at sequence 828, ESign server 101 may look up the base station ID, stop the service timer, and calculate the service response time. ESign server 101 may send separate alert messages, e.g. AlertControl packets, to Base station 106 at sequence 830 and ESign 120 at sequence 832 to stop alert indicators. At sequence 834, ESign server 101 may send an additional message including service response time to Staff personnel.

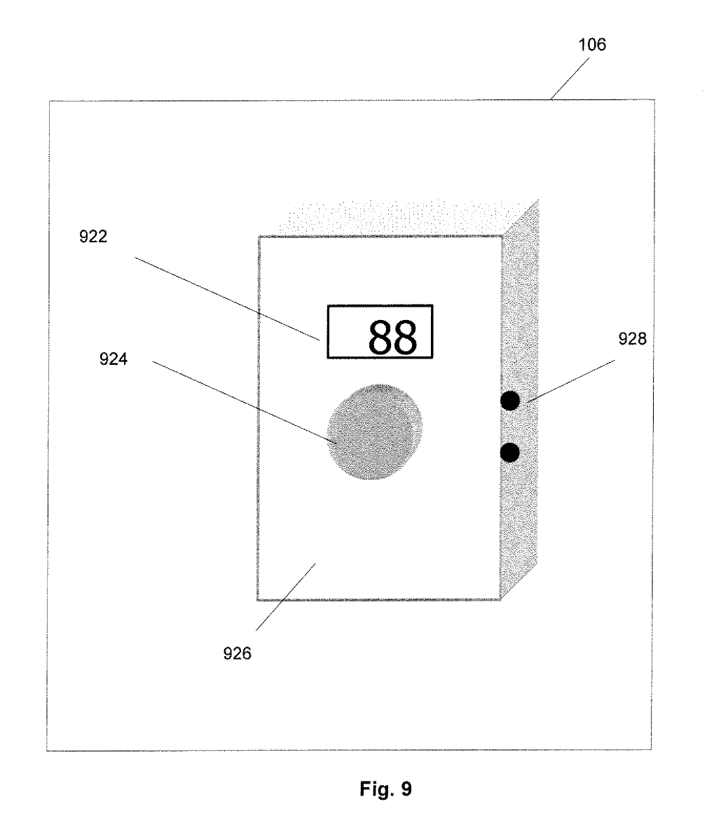

FIG. 9 illustrates an exemplary embodiment of a station alert device, such as, for example, a base station. Base station 106 may comprise location indicator 922, alert indicator 924, status indicator 926, and input device 928. In one embodiment, location indicator 922 may include multiple-character alphanumerical display; alert indicator 924 may include large, bright LED devices; status indicator 926 may include multiple LED devices; and input device 928 may include push buttons. A store staff may use input device 928 to set a location for the base station location. Location indicator 922 may display a location easily viewable by either customers or store personnel. Alert indicator 924 may use either light or audio signals to indicate different service requests are needed within the coverage of base station 106. Status indicator 926 typically shows the operating conditions, such as a network connectivity and an error condition of the base station 106.

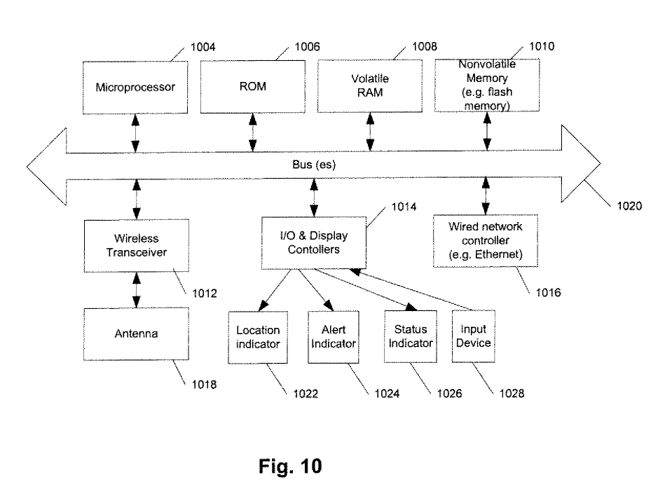

FIG. 10 illustrates an exemplary data processing system which may be used in an embodiment of a station alert device of the present invention. A station alert device may be a base station or a standalone alert device. Note that while FIG. 10 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 10, the data processing system, includes a bus 1020 that is coupled to a microprocessor(s) 1004, a ROM (Read Only Memory) 1006, volatile RAM 1008, and a non-volatile memory 1010. The microprocessor 1004 may retrieve the instructions from the memories 1006, 1008, 1010 and execute the instructions to perform operations described above. The bus 1020 interconnects these components 1004, 1006, 1008, and 1010 to I/O (input/output) and display controllers 1014 that is coupled with location indicator 1022, alert indicator 1024, status indicator 1026, and input device 1028. The volatile RAM (Random Access Memory) 1008 is typically implemented as dynamic RAM (DRAM) that requires power continually in order to refresh or maintain the data in the memory.

Additionally, a wireless transceiver 1012 may be coupled with bus 1020 to provide an interface to a wireless network. The wireless transceiver 1012 may be a radio frequency (RF) transceiver (e.g., an RF transceiver for an ZigBee wireless network or a Wi-Fi transceiver for IEEE 802 based wireless network.) Transceiver 1012 may be coupled with an antenna system 1018. A wired network controller 1016 may be coupled with bus 1020 to interface with other networks via Ethernet.

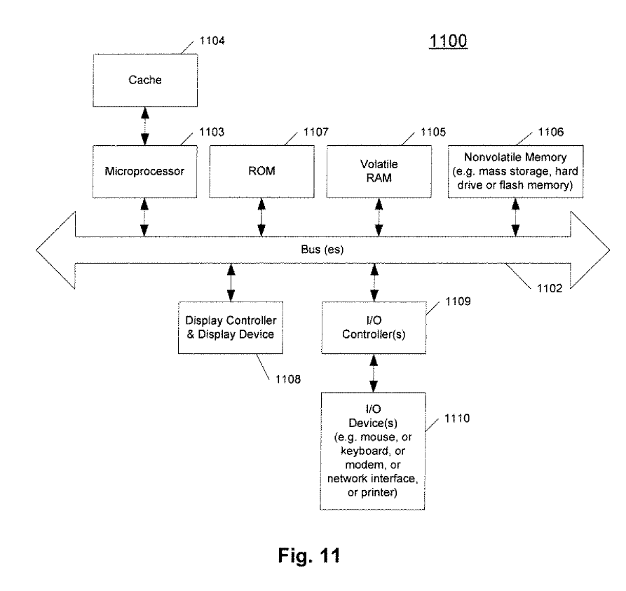

FIG. 11 illustrates one example of a typical computer system which may be used in an ESign server in conjunction with the embodiments described herein. For example, the system 1100 may be implemented as a part of the system shown in FIG. 5. Note that while FIG. 1100 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 11, the computer system 1100, which is a form of a data processing system, includes a bus 1102 which is coupled to a microprocessor(s) 1103 and a ROM 1107, a volatile RAM 1105 and a non-volatile memory 1106. The microprocessor 1103 may retrieve the instructions from the memories 1107, 1105, 1106 and execute the instructions to perform operations described above. The bus 1102 interconnects these various components together and also interconnects these components 1103, 1107, 1105, and 1106 to a display controller and display device 1108 and to peripheral devices such as I/O devices which may be mice, keyboards, modems, network interfaces, printers and other devices which are well known in the art. Typically, the I/O devices 1110 are coupled to the system through I/O controllers 1109. The volatile RAM 1107 is typically implemented as dynamic RAM (DRAM).

The mass storage 1106 is typically a magnetic hard drive or a magnetic optical drive or an optical drive or a DVD RAM or a flash memory or other types of memory systems which maintain data (e.g. large amounts of data) even after power is removed from the system. Typically, the mass storage 1106 will also be a random access memory although this is not required. While FIG. 11 shows that the mass storage 1106 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 1102 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A machine-implemented method, comprising:
associating presentation information with an electronic sign wirelessly placed within a proximity of one or more object items, the presentation information describing at least a portion of content of the one or more object items;
in response to a signal received from the electronic sign displaying the presentation information, determining an alert message for the one or more object items based on the received signal; and
wirelessly transmitting the alert message to the electronic sign to modify at least a portion of the displayed presentation information.

2. The method of claim 1, wherein the electronic sign is associated with an identifier uniquely representing the electronic sign, wherein the signal includes the identifier and wherein the method further comprises:
updating a status of the electronic sign according to the identifier; and
generating the alert message including the status of the electronic sign, wherein the alert message is generated based on set of programmable rules in view of the status of the electronic sign.

3. The method of claim 2, wherein the signal includes a service request transmitted via an input/output device coupled with the electronic sign.

4. The method of claim 2, wherein the electronic sign is placed at a location having one or more alert devices that are positioned within a proximity of the location, and wherein the method further comprises:
determining the location of the electronic sign based on the identifier extracted from the signal received from the electronic sign;
selecting one or more of the alert devices according to the determined location; and
sending an alert command to activate the selected one or more alert devices.

5. The method of claim 1, wherein the alert message includes a default presentation message and wherein the electronic sign displays the default presentation message at the display in response to the received alert message.

6. The method of claim 1, wherein the alert message includes an action command causing the electronic sign to activate an alert device.

7. A machine-readable storage medium having instructions stored therein, which when executed, cause a machine to perform a method, the method comprising:
associating presentation information with an electronic sign wirelessly placed within a proximity of one or more object items, the presentation information describing at least a portion of content of the one or more object items;
in response to a signal received from the electronic sign displaying the presentation information, determining an alert message for the one or more object items based on the received signal; and
wirelessly transmitting the alert message to the electronic sign to modify at least a
portion of the displayed presentation information.

8. The medium of claim 7, wherein the electronic sign is associated with an identifier uniquely representing the electronic sign, wherein the signal includes the identifier and wherein the method further comprises:
updating a status of the electronic sign according to the identifier; and
generating the alert message including the status of the electronic sign, wherein the alert message is generated based on set of programmable rules in view of the status of the electronic sign.

9. The medium of claim 8, wherein the signal includes a service request transmitted via an input/output device coupled with the electronic sign.

10. The medium of claim 8, wherein the electronic sign is placed at a location having one or more alert devices that are positioned within a proximity of the location, and wherein the method further comprises:
determining the location of the electronic sign based on the identifier extracted from the signal received from the electronic sign;
selecting one or more of the alert devices according to the determined location; and
sending an alert command to activate the selected one or more alert devices.

11. A machine implemented method performed by an electronic sign, the method comprising:
in response to receiving wirelessly an identifier representing a machine readable code printed on a surface of an object at a location within a proximity of the electronic sign, displaying presentation information at a display of the electronic sign, the presentation information being associated with the identifier at a remote server;
in response to detecting an absence of the object from the proximity of the location while the presentation information is being displayed, wirelessly sending a notification signal to the remote server; and
activating an alert according to an alert message received from the remote server based on the notification signal.

12. The method of claim 11, wherein the detection of the absence comprises:
determining a time interval during which the object is absent from the location; and
comparing duration of the time interval with a reference duration, wherein the notification signal is wirelessly sent to the remote server when the duration of the time interval exceeds a predetermined threshold.

13. The method of claim 11, wherein the activation of the alert comprises:
displaying the alert message at the display to replace the presentation information.

14. The method of claim 11, wherein the electronic sign is coupled with one or more audio-visual alert indicators, wherein the alert message includes an alert pattern and wherein the activation of alerts comprises:
presenting the alert pattern via the one or more audio-visual alert indicators.

15. The method of claim 11, further comprising:
displaying a default message at the display according to the detection of the absence of the object.

16. The method of claim 15, further comprising:
retrieving the default message from a storage in the electronic sign.

17. An apparatus for an electronic sign, comprising:
in response to receiving wirelessly an identifier representing a machine readable code printed on a surface of an object at a location within a proximity of the electronic sign, means for displaying presentation information at a display of the electronic sign, the presentation information being associated with the identifier at a remote server;
means for detecting an absence of the object from the proximity of the location;
in response to detecting the absence of the object while the presentation information is being displayed, means for wirelessly sending a notification signal to the remote server; and
means for activating an alert according to an alert message received from the remote server based on the notification signal.

18. The apparatus of claim 17, wherein the means for detecting the absence comprises:
means for determining a time interval during which the object is absent from the location; and
means for comparing duration of the time interval with a reference duration, wherein the notification signal is wirelessly sent to the remote server when the duration of the time interval exceeds a predetermined threshold.

19. The apparatus of claim 18, wherein the means for activating the alert comprises:
means for displaying the alert message at the display to replace the presentation information.

20. A system comprising:
a server;
a plurality of electronic signs communicatively coupled to the server,
wherein each electronic sign displays presentation information at a display of the electronic sign in response to wirelessly receiving an identifier representing a machine readable code printed on a surface of an object at a location within a proximity of the electronic sign, the presentation information being associated with the identifier at the server,
wherein the electronic sign detects an absence of the object from the proximity of the location while the presentation information is being displayed,
wherein the electronic sign wirelessly sends a notification signal to the server in response to detecting the absence of the object; and
wherein the electronic sign activates an alert according to an alert message received from the server based on the notification signal.
